(19) United States
(12) Patent Application Publication
(10) Pub. No.: US 2004/0264720 A1
(43) Pub. Date: Dec. 30, 2004

(54) Wireless earphone having replaceable battery module

(76) Inventors: Chen Liang Huang, Hsintien City (TW); Chin Shing Wang, Chungho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/607,053

(22) Filed: Jun. 27, 2003

(51) Int. Cl. H04R 25/00

(52) U.S. Cl. 381/315; 381/381; 381/370; 381/330

(57) ABSTRACT

A wireless earphone with a replaceable battery module has a body having the function of a wireless earphone and a hook having a battery module therein. A cavity is formed on the body. Two conducting sheets are provided near the cavity. The two conducting sheets are connected to a power source circuit in the body. Two conducting contacts are formed at one end portion of the hook. The two conducting contacts are connected to a power source circuit of the battery module. When one end portion of the hook is inserted into the cavity in the body, the two conducting contacts contact the two conducting sheets at two sides of the body so that the battery module can provide electricity to the body. When the electricity of the module is insufficient, the hook can be replaced to recharge the battery module for further use.

### FIELD OF THE INVENTION

The present invention relates to a wireless earphone having a replaceable battery module and, more particularly, to a wireless earphone whose battery module is replaceable.

### BACKGROUND OF THE INVENTION

Generally, a battery module of an existent wireless earphone is directly arranged in the body thereof. Once the electricity of the battery module is insufficient, it is necessary to replace the whole wireless earphone even if the function of the wireless earphone is O.K.

Accordingly, the present invention aims to provide a wireless earphone having a replaceable battery module to solve the above problem.

### SUMMARY OF THE INVENTION

One object of the present invention is to provide a mechanism with a body having the function of a wireless earphone and capable of directly replacing the battery module thereof.

Another object of the present invention is to provide a device capable of shrinking the size of the whole wireless earphone.

To achieve the above objects, in the present invention, a cavity is formed in a body having the function of a wireless earphone. Two conducting sheets are provided near the cavity. The two conducting sheets are connected with a power source circuit in the body. A hook having a battery module therein is also provided. Two conducting contacts are formed at one end portion of the hook. The two conducting contacts are connected with a power source circuit of the battery module.

The above hook is composed of a fixing portion and an arc-shaped bent portion extending from the fixing portion.

### BRIEF DESCRIPTION OF THE DRAWINGS:

The various objects and advantages of the present invention will be more readily understood from the following detailed description when read in conjunction with the appended drawings, in which:

FIG. 1 is an exploded perspective view of the present invention;

FIG. 2 is another exploded perspective view of the present invention;

FIG. 3 is yet another exploded perspective view of the present invention;

FIG. 4 is an assembly view of FIG. 3; and

FIG. 5 is an exploded perspective view according to another embodiment of the present invention.

### DETAILED DESCRIPTION OF THE PREFERRED EMBODIMENTS

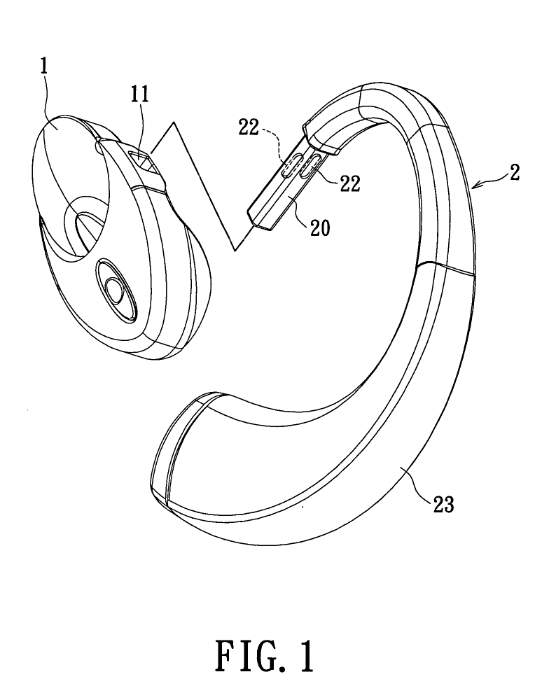

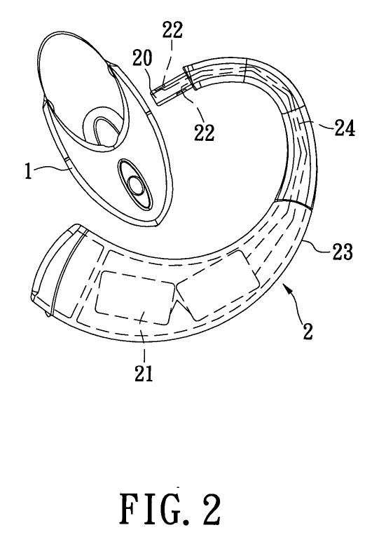

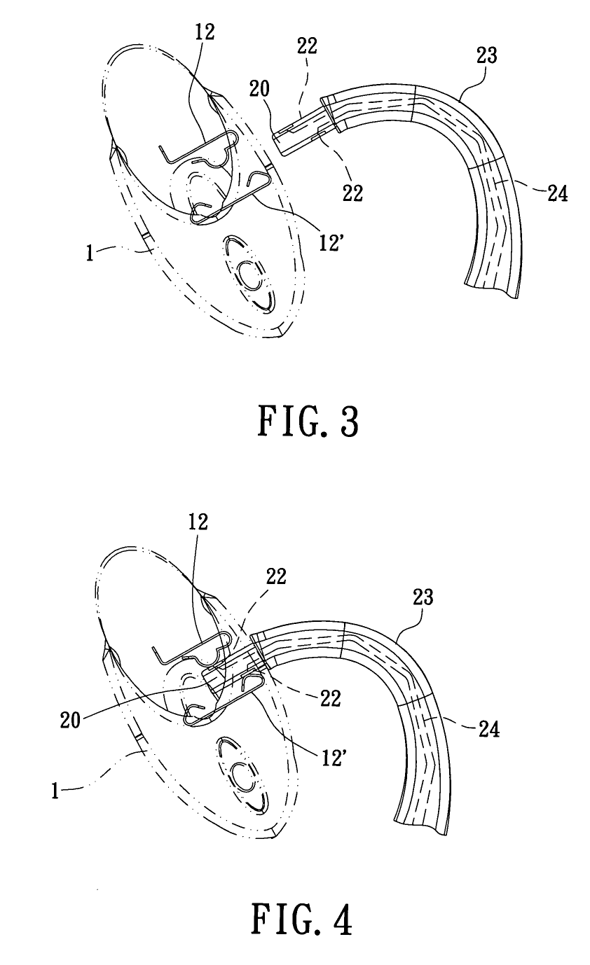

As shown in FIGS. 1 to 4, a wireless earphone having a replaceable battery module of the present invention comprises a body 1 having the function of a wireless earphone and a hook having a replaceable battery module therein.

A cavity 11 is formed in the right side of the body 1. Two conducting sheets 12 and 12′ are provided near the cavity 11. The two conducting sheets 12 and 12′ are connected to a power source circuit in the body 1.

A fixing portion 20 is formed at one end of the hook 2. Two conducting contacts 22 are formed on the fixing portion 20. The two conducting contacts 22 are connected to a power source circuit of a battery module 21 via leads 24. An arc-shaped bent portion 23 extends from the fixing portion 20 to hang on an ear of a user.

When the fixing portion 20 of the hook 2 is inserted into the corresponding cavity 11 of the body 1, the two conducting contacts 22 contact the two conducting sheets 12 and 12′ at two sides of the body 1 so that the battery module 21 can provide the working power source for the body 1.

Because the hook 2 can be removed from the cavity 11 of the body 1, when the electricity of the battery module 21 is insufficient, the hook 2 can be replaced to recharge the battery module for further use.

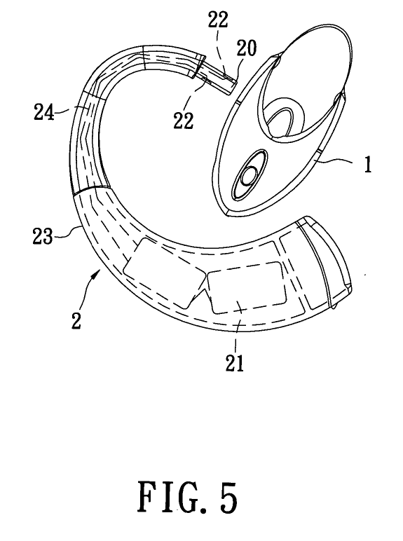

As shown in FIG. 5, it is also feasible that a cavity (not shown) be formed in the left side portion of the body 1 for exchangeable use of the hook 2.

To sum up, the present invention has the following characteristics:

1. Because the hook can be taken out from the body having the function of a wireless earphone, the size of the whole wireless earphone can be reduced.

2. An expended battery module can be replaced with a new battery module.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A wireless earphone having a replaceable battery module comprising:
a body having the function of a wireless earphone, a cavity being formed in said body, two conducting sheets being provided near said cavity, and said two conducting sheets being connected with a power source circuit in said body; and
a hook having a replaceable battery module therein, two conducting contacts being formed at one end portion of said hook and said two conducting contacts being connected to a power source circuit of said battery module;
whereby when one end portion of said hook is inserted into said cavity of said body, said two conducting contacts contact said two conducting sheets at two sides of said body so that said battery module provides electricity to said body.

2. The wireless earphone having a replaceable battery module as claimed in claim 1, wherein said hook is composed of a fixing portion and an arc-shaped bent portion extending from said fixing portion.
